(19) United States
(12) Patent Application Publication
(10) Pub. No.: US 2013/0065973 A1
(43) Pub. Date: Mar. 14, 2013

(54) MIXING OR DISPERSING ELEMENT AND PROCESS FOR STATIC MIXING OR DISPERSING

(71) Applicants: Sebastian Hirschberg, Winterthur (CH); Marcel Suhner, Wiesendangen (CH)

(72) Inventors: Sebastian Hirschberg, Winterthur (CH); Marcel Suhner, Wiesendangen (CH)

(21) Appl. No.: 13/636,581

(22) PCT Filed: Oct. 8, 2010
(86) PCT No.: PCT/EP2010/065146

§ 371 Date: Nov. 28, 2012

(30) Foreign Application Priority Data
Mar. 22, 2010 (EP) 10157132.1

(51) Int. Cl. B01F 3/00; B01F 15/02; B01F 15/06

(52) U.S. Cl. CPC B01F 3/0092; B01F 15/06; B01F 15/0216
USPC 516/9; 366/340; 366/144; 366/152.2; 422/224

(57) ABSTRACT

A mixing or dispersing element (1, 10, 30, 40, 50, 60, 70) includes a passage (2) in which an insertion element (3, 4. 33, 34) is arranged which contains a foam structure. A static mixing element (5, 6, 35, 36) for macro mixing or predispersing or macro dispersing is arranged in the passage (2) in addition to the insertion element (3, 4, 33, 34) for micro mixing or dispersing. Furthermore, a method is described of producing a dispersion using such a mixing or dispersing element.

The invention relates to a static mixing or dispersing element as well as to a method of mixing and/or dispersing liquids, suspensions, gases or liquids and gases.

Liquids and/or gases have to be mixed and/or dispersed in various applications. Static mixers having static mixing elements which are designed in accordance with DE 22 05 371 or in accordance with CH 642 564 are, as is known, very suitable for this process step.

Static mixers are composed of coarsely structured mixing structures such as bars, passages and plates which are arranged in an orientated manner and which generate a mixing and dispersing effect by vortex formation and stratification when the liquids, suspensions and gases flow through. A mixing structure is termed coarsely structured when the number of intersections of the mixer structure with an arbitrarily disposed cross-sectional surface amounts to a maximum of 20. The cross-sectional surface is disposed normally to the longitudinal axis of the static mixer, that is normally to the main direction of flow.

To achieve a good mixing and/or dispersing effect with static mixers as well as, in particular in reactions, a good mass transfer, a specific number of mixing elements, a specific dwell time and a specific shear input are required in dependence on the desired result. This then results in a required construction length and in a required energy input. Both the energy input and the construction length of a static mixer should naturally be kept as low as possible for a given piece of work. The energy input and the construction length of pure static mixers depend on their geometry. In all cases, the energy input and the construction length are relatively large for the corresponding mixing work.

To optimize the construction length and the energy input of such static mixers, it also has been proposed to combine mixers with mixing elements of different scales, such as is shown in WO2010066457. The efficiency of the mixer can hereby admittedly be somewhat improved, but is very complex and/or expensive due to the necessity of the manufacture of a plurality of different mixing elements, in particular when the mixing elements have a small scale mixing structure.

Open pore, unstructured, fine-cell foam structures such as disclosed in DE 103 27 986 have also been proposed for the mixing, dispersing and for the heat exchange. These structures are characterized by a large surface per volume unit. The mixing, dispersing and the heat exchanger is very good and efficient in the micro region due to the large contact surface. A micro region is understood as a part of the mixer cross-section which is characterized by a mixing effect topically restricted to the micro region. The micro region is as a rule less than 25% of the cross-sectional surface. A macro region is understood as the total mixer cross-section which is characterized by a mixing effect extending over the total mixer cross-section.

The great disadvantage of the foam structures is, however, that the undirected structures effect a very poor transverse transport and thus large-scale concentration and temperature differences can only be reduced insufficiently and slowly. If homogeneous mixtures, dispersions, emulsions and temperatures should be achieved over the whole cross-section, relatively long voluminous installation elements result which also generate a relatively large pressure loss. A combination of foam structures of different pore size can also effect an improvement in efficiency in this case, with the basic problem of the lack of transverse exchange remaining.

It is the object of the invention to achieve a mixing, dispersing or reaction of liquids, suspensions, gases or liquids and gases with as little energy input as possible and with an installation length which is as short as possible.

The object of the invention is satisfied by a mixing or dispersing element which includes a passage in which an insertion element including a foam structure is arranged. A static mixing element for macro mixing or for pre-dispersing or for macro dispersing is additionally attached in the passage, with it preferably being arranged upstream of the insertion element, at least partly.

Macro mixing is understood in this application as a large-scale mixing taking place in a large part of the cross-sectional surface of the mixing or dispersing element. Dispersing is spoken of when at least one non-miscible second fluid is distributed in a first fluid. The first fluid forms a first phase, the second fluid a second phase. Predispersing is understood as the breaking down of the non-miscible second phase into relatively large drops of typically more than 1 mm which are distributed over the total cross-sectional surface of the mixing or dispersing element. Macro dispersing is understood as the uniform distribution of existing drops over the total cross-sectional surface of the mixing or dispersing element.

The static mixing element is preferably designed as a first static mixing element and at least one second static mixing element is arranged downstream of the insertion element.

At least one second insertion element can be arranged downstream of the second static mixing element to achieve an even better dispersing.

In accordance with an alternative embodiment, at least one of the static mixing elements can contain an insertion element.

A spacing can be formed between the insertion element or at least one of the first or second insertion elements and the static mixing element.

The insertion element can in particular contain a foam structure which is open pore. A foam structure which is characterized as open pore should in the following be understood as a foam structure in which the individual pores are not separated from one another by walls. The pore can be considered as a hole or as a hollow space. There are large openings between adjacent pores through which a fluid can flow. The walls between the pores are practically completely removed for an open pore foam structure. The openings in the walls are so large that only one bar remains of the wall which forms the marginal boundary of adjacent pores. A plurality of bars can evidently also be provided.

The foam structure can include a metal, a metal alloy, in particular an aluminum alloy, a ceramic material, glass, carbon and/or a plastic. This foam structure has the advantage that it has a very large inner surface which can be utilized for braking open and comminuting the phase boundary.

The foam structure can have a pore size up to and including 100 PPI. PPI is a customary measure for characterizing the pore size of a foam structure. It is the abbreviation for “pores per inch”. The pore size particularly preferably lies in a range from 10 up to and including 100 PPI.

The free volume portions of the foam structure which can be used for the dispersing element amount from 40% to 97%, preferably from 50% to 95%.

A foam structure can be manufactured by means of different processes. For example, in a first process step, an open pore polyurethane foam can be used as a model. A substantial advantage in the use of a polyurethane foam is that the most varied shapes and pore sizes can be manufactured industrially in a defined manner. In a second process step, a mold for light metal casting can be manufactured from the polyurethane foam using a lost mold. The mold contains the desired foam structure. CVD techniques or other processes which are based on polyurethane foams as precursors are also used in the industry for the production of foam structures. In addition, various other processes are being developed or are already in use for producing open pore foam structures. Alternatively, a foam structure can also be manufactured in a computer-assisted manner by means of rapid manufacturing techniques from different materials, in particular the aforesaid materials. A process is understood as rapid manufacturing in which a spatial geometry takes place by a layer-wise building, with the layers preferably being produced by the melting of powders.

Surprisingly, the required power input and energy input can be reduced by up to 80% with respect to conventional static mixers by the use of a foam structure in combination with a static mixer for mixing and/or dispersing. Compact mixing or dispersing elements can thereby be built. In this context, compact means that the length of the mixing or dispersing element is reduced in comparison with the length of a pure static mixing element. The reduction of the length can be between 10% and 60%. The obtained foam structure preferably has a length L and a diameter D, with the ratio L/D being smaller than 5, preferably smaller than 3, particularly preferably smaller than 2. Surprisingly, it becomes possible with a ratio L/D of smaller than 5 in combination with static mixing elements to manufacture mixtures and dispersions of the same quality as with the static mixing element already known from the prior art.

The mixing or dispersing element is in particular suitable for the production of mixtures, emulsions, dispersions or foams. In this application, the term dispersion stands for systems in which drops and/or bubbles are larger than approximately 50-100 micrometers. The term emulsion is used for systems having smaller drops and/or bubbles.

Each of the insertion elements can contain a foam structure having a different pore size. The foam structure preferably includes a metal, a metal alloy, a ceramic material, glass, carbon and/or a plastic.

The mixing or dispersing element in accordance with one of the preceding embodiments can also contain a temperature adjusting means. For example, the passage can be equipped with a temperature adjusting means or can be surrounded by a temperature adjusting means.

At least a part of the mixing or dispersing element can be designed as a catalyst surface, in particular as a hydrolysis catalyst surface.

The mixing or dispersing element can be used either for processing already premixed or predispersed fluid systems or the liquid phase or gas phase to be mixed or to be disperses is metered in during the processing. If the fluid to be mixed or dispersed is metered in, at least one metering element can open into the passage in which the mixing or dispersing element is arranged. The metering element serves for the input of a fluid into the first liquid flowing in the passage. The fluid can be a gas or a second liquid. The fluid and the first liquid in particular flow through the passage in parallel flow.

The metering element is advantageously arranged upstream of the dispersing element. It is also possible to install a metering element into the dispersing elements. A plurality of metering elements can also open into the passage or be installed in the dispersing element for the uniform distribution of the phase to be dispersed.

The metering element can be designed as a pipe with metering openings. The metering opening can be designed as a nozzle, for example. A curvature can be provided in the region of the metering opening so that the phase to be dispersed can be ideally distributed in the dispersing element. For the better distribution of the phase to be dispersed, the supply line can feed a plurality of metering elements so that the number of the feed points arranged in the passage for the phase to be dispersed is increased.

The method of generating a mixture or dispersion in accordance with the invention includes the following steps: in a first step, a first fluid and a second fluid are simultaneously introduced into a passage, wherein the first fluid is brought into contact with the second fluid in a second step in a mixing or dispersing element, wherein the mixing or dispersing element contains an insertion element for the micro mixing or dispersing which contains a foam structure which is arranged in the passage as well as additionally a static mixing element for macro mixing or for predispersing or for macro dispersing is arranged in the passage, and wherein the first fluid and the second fluid are conducted in parallel flow through the mixing or dispersing element and through the insertion element, whereby the second fluid and the first fluid are mixed or dispersed.

The first fluid can be a first liquid or a first gas and the second fluid can be a second liquid or a second gas.

The method of generating a mixture or dispersion is used e.g. in the manufacture of dispersions or emulsions in foods, household products or cosmetics. A dispersion is also necessary in the production of large surfaces for reactions, in the dissolving of a gas in a liquid, such as in the water treatment by ozone. The method is also specifically suitable for mixing liquids having large viscosity differences and/or very different volume flow relationships or for mixing liquids with poor wetting. Gases can be purified efficiently and with very low pressure loss by the addition of washing liquids. Liquids can also be metered into a gas flow by means of a spray nozzle and can be vaporized fast and completely using the apparatus.

The invention will be explained in the following with reference to the drawings. There are shown:

FIG. 1 a schematic view of an insertion element having a foam structure;

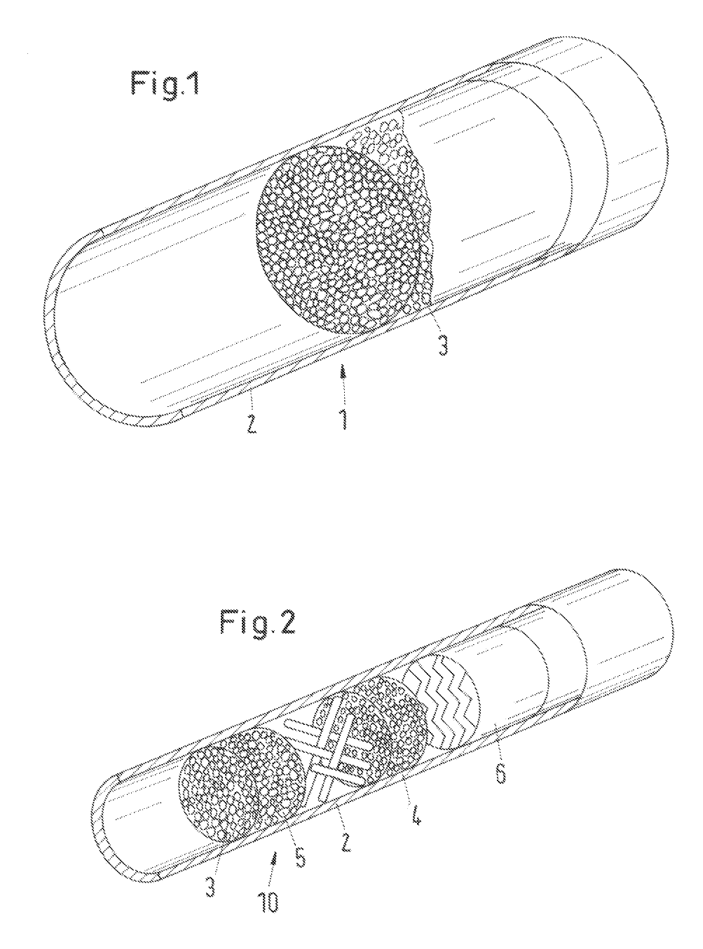

FIG. 2 a mixing or dispersing element having an insertion element in accordance with FIG. 1 in accordance with a first embodiment;

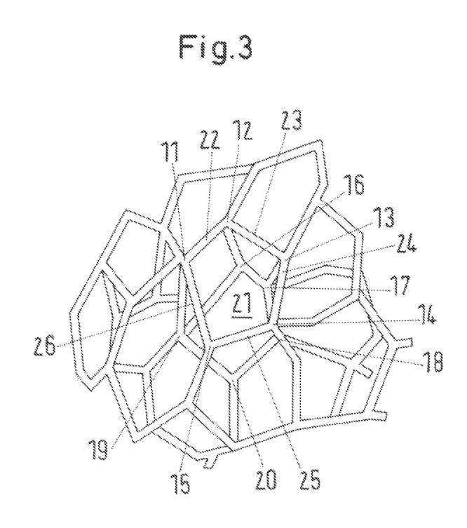

FIG. 3 a detail of an open pore foam structure of the insertion element;

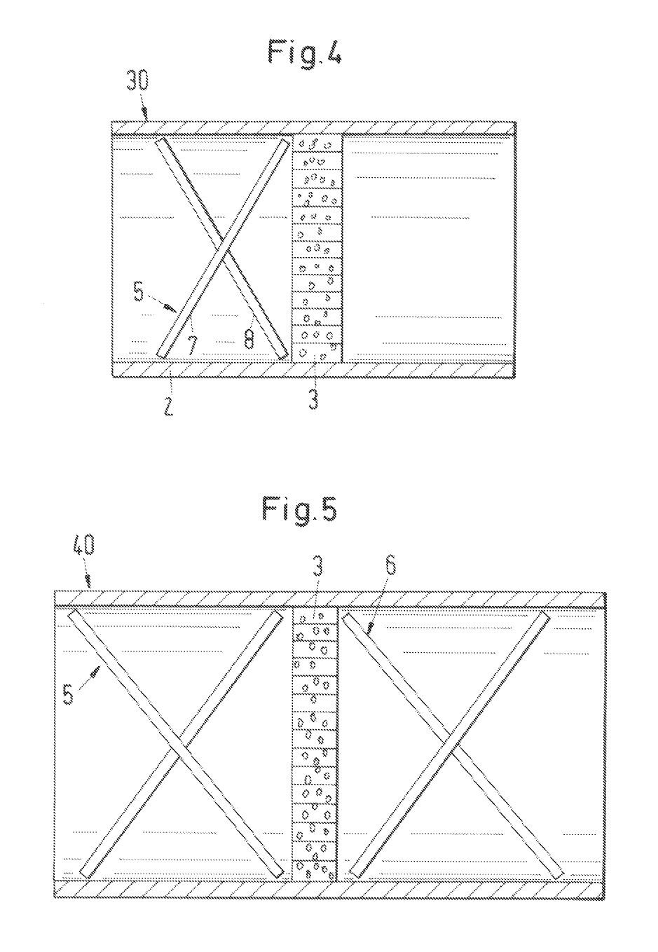

FIG. 4 a section through a mixing or dispersing element in accordance with a second embodiment;

FIG. 5 a section through a mixing or dispersing element in accordance with a third embodiment;

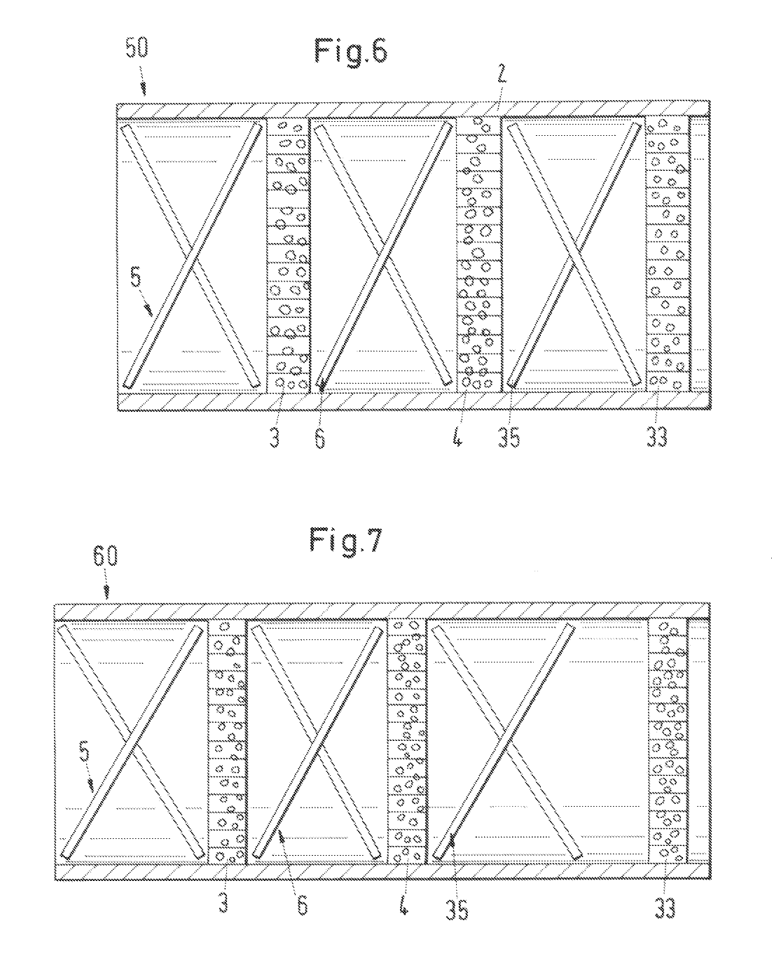

FIG. 6 a section through a mixing or dispersing element in accordance with a fourth embodiment;

FIG. 7 a section through a mixing or dispersing element in accordance with a fifth embodiment; and

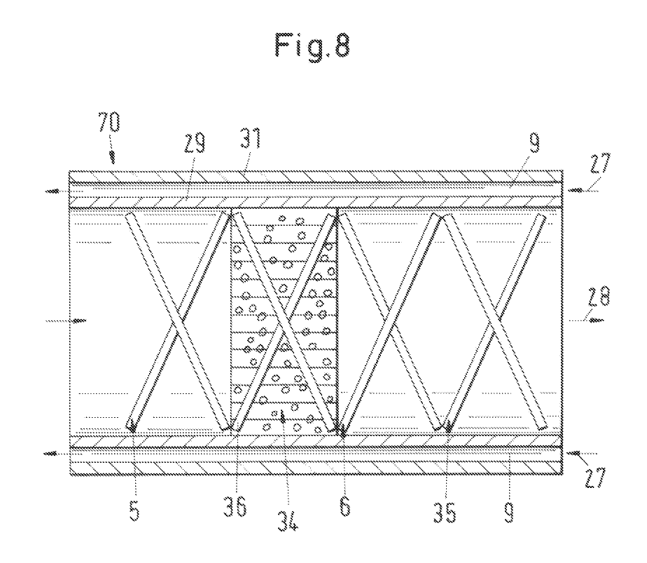

FIG. 8 a section through a mixing or dispersing element in accordance with a sixth embodiment.

The mixing or dispersing element 1 in accordance with FIG. 1 includes a passage 2 in which an insertion element 3 is arranged which contains a foam structure. The passage is shown partly in section in FIG. 1 so that the insertion element is visible. The insertion element in accordance with FIG. 1 is completely composed of the foam structure. Optionally, the foam structure can be surrounded by a jacket element to facilitate the installation into the passage 2.

The passage 2 in accordance with FIG. 1 is shown as a pipe with a circular cross-section. The passage can naturally have any other desired cross-sectional shapes, can in particular be made in rectangular shape.

A mixing or dispersing element 10 is shown in FIG. 2. The mixing or dispersing element likewise includes a passage 2 in which a first and a second insertion element 3, 4 are arranged. A first static mixing element 5 which is designed in accordance with CH 642 564 is provided between the first and second insertion elements 3, 4. Furthermore, a second static mixing element 6 is shown whose installations substantially correspond to DE 22 05 371. The first static mixing element 5 is arranged directly adjacent to the first and second insertion elements. The second static mixing element 6 is arranged at a spacing from the second insertion element 4.

A metering element to introduce a fluid into the liquid flowing through the passage 2 is not shown in the drawing. Such a metering element is shown, for example, in EP 1 956 206 A2.

This embodiment is only an exemplary representation of a possible arrangement of mixing or dispersing elements and of static mixing elements to form a mixing or dispersing unit; the invention is in no way to be considered as restricted to this embodiment.

FIG. 3 shows an example for a foam structure which is open pore. The section shown in FIG. 3 can, for example, be integrated into one of the foam structures in accordance with FIG. 1 or FIG. 2. The pore is a hole or hollow space which is bounded by the corner points 11, 12, 13, 14, 15, 16, 17, 18, 19, 20 in FIG. 3. The individual pores are not separated from one another by walls. The surface which is spanned by the corner points 11, 12, 13, 14, 15 is formed as an opening 21, for example. This opening 21 is located between the above-named pore and the pore, not shown in the drawing, which lies in front of the drawing plane. Adjacent pores can be flowed through by a fluid through the openings. The opening 21 is bounded by bars 22, 23, 24, 25, 26 which form the marginal boundary of adjacent pores.

Practice has shown that on the use of foam structures for micro mixing and/or dispersing in parallel flow operation, hardly any actual maldistribution occurs and the large inner surface of the foam structure results in a very efficient micro mixing and dispersing. Micro mixing is defined as a mixing effect restricted to a micro region. Micro mixing is thus understood as a zonarily bounded mixing which is not effective over the total cross-section of the mixing or dispersing element. Maldistribution is to be understood in this respect as an uneven intermixing. If a section were placed through a cross-sectional surface of the dispersing element, zones with sufficient intermixing having zones of defective intermixing would become visible. This means that for parts of the cross-sectional surface, the intermixing is below an expected value, that is is a zone of defective intermixing; for other parts of the cross-sectional surface, the intermixing corresponds to the expected value or exceeds the expected value, that is a zone of sufficient intermixing is present.

A large-scale mixing is not achievable with a foam structure alone since foam structures are undirected. Large-scale mixing is understood in this respect as a mixing process in which fluid or gas is moved over larger distances perpendicular to the main direction of flow and inhomogeneities in the distribution of the individual components in the fluid or in the gas in planes perpendicular to the main direction of flow are compensated by the movement of the fluid or gas. A combination of classical static mixing elements for large-scale mixing and predispensing with foam structures for micro mixing and fine dispersing is therefore advantageous. Fine dispersion is understood as the result of the micro dispersing, that is a dispersion or emulsion, in which the dispersed phase is present with a maximum drop size of smaller than 2 mm, preferably smaller than 1 mm. A sufficient large-scale mixing can also not be achieved by the combination of foam structures of different pore size.

It is also possible to use a packing of spheres which is likewise open pore. A major difference of packings of spheres from the previously described foam structures is that packings of spheres typically have 25%-40% free volume and thus a much worse ratio of volume to surface as well as larger pressure losses. The described foam structures have a free volume from 40% up to including 97%.

FIG. 4 shows a mixing or dispersing element 30 in accordance with a second embodiment of the invention which has a static mixing element 5 as well as an insertion element 3. A flow passage 2 is shown cut away along its longitudinal axis for this purpose. The static mixing element 5 contains a first arrangement 7 of bar elements and a second arrangement 8 of bar elements. Two respective adjacent bar elements belong either to the first arrangement 7 or to the second arrangement 8. Each of the first or second arrangements can contain a plurality of bar elements. The bar elements represent an obstacle for the fluid flow, the bar elements are flowed around by the fluid, whereby a deflection and/or vortex formation of the fluid flow results. An intermixing takes place by this deflection and/or vortex formation of the flow. The bar elements can in particular be designed in accordance with CH 642 564 or EP 0 526 392 A1. The throughflow direction can take place through the mixing element first and then through the foam structure, or vice versa, depending on the application.

The insertion element 3 which is designed in accordance with one of FIGS. 1 to 3 is arranged downstream of the static mixing element.

FIG. 5 shows a mixing or dispersing element 40 in accordance with a third embodiment of the invention which has a static mixing element 5 as well as an insertion element 3. The insertion element 3 is arranged downstream of the static mixing element 5. A further static mixing element 6 is arranged downstream of the insertion element 3. The static mixing element 6 can have the same structure as the static mixing element 5 which can in particular be designed as in FIG. 4. Alternatively to this, the static mixing element 6 and/or the static mixing element 5 can also have a different manner of construction, as is shown, for example, in FIG. 2 for the static mixing element 6 shown there.

FIG. 6 shows a mixing or dispersing element 50 in accordance with a fourth embodiment of the invention which has a first static mixing element 5 as well as a first insertion element 3 which is arranged downstream of the first static mixing element 5. Following the first insertion element 3, that is downstream thereof, a second static mixing element 6 is arranged. A second insertion element 4 is arranged downstream of the static mixing element 6. A third static mixing arrangement 35 is arranged downstream of the second insertion element 4 and a third insertion element 33 is arranged downstream of this third static mixing element. It is naturally possible to arrange further static mixing elements and/or insertion elements in a respective alternating sequence. It is also possible to form a group of at least 2 insertion elements which is arranged following a static mixing element or a group of at least 2 static mixing elements.

It is naturally also possible to arrange at least one of the static mixing elements at an angle relative to one of the other static mixing elements. The position of a first static mixing element can in particular be rotated by 90° about the longitudinal axis of the passage relative to the second static mixing element.

FIG. 7 shows a mixing or dispersing element 60 in accordance with a fifth embodiment of the invention. This dispersing element has the same arrangement of static mixing elements 5, 6, 35 and the same arrangement of insertion elements 3, 4, 33 as FIG. 6; however, the insertion element 33 has a spacing from the static mixing element 35. Such a spacing can be advantageous to provide a longer mixing path downstream of the static mixing element so that the individual fluid strands intermix which are formed by the deflection of the fluid flow along the surfaces of the first and second arrangements 7, 8 of the bar elements.

The spacing can naturally also be provided at every other point of the mixing or dispersing elements 60. It is also possible to provide corresponding spacings in the mixing or dispersing elements 1, 10, 30, 50 of the preceding embodiments or in the dispersing element 70 of the following embodiment.

FIG. 8 shows a mixing or dispersing element 70 in accordance with a sixth embodiment of the invention. This mixing or dispersing element 70 contains four static mixing elements 5, 6, 35 and 36 arranged in series. One of the static mixing elements, here the static mixing element 36, is installed in an insertion element 34. The static mixing element 36 and the insertion element 34 are thus flowed through simultaneously by the fluid mixing. The operation of the static mixing element can hereby be combined with the operation of the insertion element, that is a large-scale transfer of the flow through the arrangements of the bar elements of the static mixing element and a micro mixing or dispersing respectively through the insertion element 34 occurs simultaneously.

In addition, FIG. 8 shows a passage 9 in which a temperature adjusting means 27 can flow. The passage 9 surrounds the passage 2 through which the fluid mixture flows. The passage 9 can in particular be formed in ring shape. This means that the passage surrounds the outer jacket surface of the housing element 29 as a further housing element 31. The housing element 29 and the housing element 31 are in this respect preferably designed as pipes. Alternatively to this, a plurality of passages can be arranged on the outer jacket surface of the housing element 29 bonding the passage 2, an embodiment which is not shown in the drawing.

The temperature adjusting means 27 flows, in accordance with FIG. 8, in counterflow to the fluid mixture 28; alternatively, a conducting in parallel flow or cross-flow is also possible.

It has been found that a combination of mixing elements with insertion elements having open pore foam structures result in very short and energy-efficient apparatus for mixing, for dispersing and emulsifying and also for the heat exchange. Depending on the object, they can be much shorter and also have a much smaller pressure loss than static mixing elements alone or insertion elements which are only comprised of foam structures. The first part of the dispersing element in accordance with one of the preceding embodiments is in this respect preferably designed by static mixing elements mixing over the whole cross-section. The static mixing element or a plurality of static mixing elements effects a large-scale first mixing or dispersing of the component metered into a fluid flow or gas flow for forming the fluid mixture.

1 to 5 static mixing elements are preferably used. The insertion element of the mixing or dispersing element 1, 10, 30, 40, 50, 60, 70 is then preferably composed of an open pore fine-cell foam. In this, the premixed or respectively the predispersed mixing of the fluid mixture is further mixed or dispersed intensively in the micro region. The foam structures used preferably have a free volume portion of more than 70%, 80%, 90%.

Specifically for the use of the mixing or dispersing element for the dispersing, a further static mixing element or a plurality of static mixing elements may be helpful to distribute the formed fine bubbles or drops homogeneously over the whole passage cross-section. Depending on the application, a plurality of sequences of static mixing elements and foam structures are also sensible depending on the application, for example on the heat exchange or in the carrying out of chemical reactions. A heat exchanger can thus, for example, be composed of a pipe having a double jacket in which the heat carrier liquid circulates. The heat energy is then conducted in or off via the pipe wall. The heat transfer is very high in the regions at which foam structures of metal are attached in the pipe due to the good heat conduction and the large surface of the foam structure. In the regions which contain one or more static mixing elements, the arising temperature gradients are compensated again over the whole cross-section and thus the driving temperature drop is again increased, which then again results in a very efficient heat exchange in the next section with foam structure. The mixing elements for the heat exchange can also be composed of pipes which are flowed through by the heat carrier medium.

If chemical reactions should take place in the mixing or dispersing element, a plurality of sequences of foam structures and static mixing elements attached in series can result in very short dwell times and high reaction yields. Particularly advantageously, a mixing or dispersing element can be used for a gas/liquid reaction which takes place in at least two phases. Phase is here to be understood as the aggregate state of the individual components. A component can, for example, be present in gaseous form, that is as a gas phase; a further component can be present in a liquid aggregate state, that is as a liquid phase.

In all embodiments, the pore size of the foam structure is preferably less than 1/5, in particular less than 1/10, particularly preferably less than 1/20 of the spacing between two adjacent bar elements, plate spacings or passage spacings. The bar elements, plate elements or passages each belong to the first arrangement 7 or to the second arrangement 8 of the static mixing elements.

It is generally also possible to combine the static mixing elements with the foam structure in the same section, with then at least some of the intermediate spaces in the mixing element being filled by an additional foam structure. There can also be empty spaces between the individual segments of mixing elements and/or foam structures. Combinations of foam structures of different pore sizes as well as different mixing elements and differently scaled mixing elements can also be combined. The foam structures and mixing elements can be manufactured from different materials such as metal, ceramic material, plastic.

The described mixing or dispersing elements are suitable for mixing, for manufacturing emulsions, dispersions, foams and for heat exchange. The manufacture of the mixing elements and of the foam structures can take place by conventional processes as well as also by rapid manufacturing. The described mixing or dispersing elements can also be manufactured very inexpensively. By the use of foam structures, the number of the static mixing elements can be significantly reduced with respect to static mixers in accordance with the prior art, which also results in much smaller pressure losses. The static mixing elements can additionally serve as support and fastening structures for the foam structures. This is especially interesting with diameters of more than 10 cm since there the foam structures can be relatively thin in relation to the pipe diameter and should be supported accordingly. The fastening preferably takes place most simply via a support element.

1. A mixing or dispersing element (1, 10, 30, 40, 50, 60, 70), including a passage (2) in which an insertion element (3, 4, 33, 34) is arranged which contains a foam structure, characterized in that a static mixing element (5, 6, 35, 36) for macro mixing or for predispersing or for macro dispersing is arranged in the passage (2) combined with at least one insertion element for micro mixing or dispersing (3, 4, 33, 34).

2. A mixing or dispersing element in accordance with claim 1, wherein a static mixing element is arranged at least partly upstream of the insertion element for premixing and predispensing.

3. A mixing or dispersing element in accordance with claim 2, wherein the static mixing element is formed as a first static mixing element (5) and at least one second static mixing element (6, 35, 36) is arranged downstream of the insertion element (3, 4, 33, 34).

4. A mixing or dispersing element in accordance with claim 3, wherein at least one second insertion element (4, 33, 34) is arranged downstream of the second static mixing element (6, 35, 36).

5. A mixing or dispersing element in accordance with claim 1, wherein at least one of the static mixing elements (36) contains an insertion element (34).

6. A mixing or dispersing element in accordance with claim 1, wherein a spacing is formed between at least one of the insertion elements (3, 4, 33, 34) and the static mixing element (5, 6, 35, 36).

7. A mixing or dispersing element in accordance with claim 1, wherein the pore size of the foam structure is less than 1/5, in particular less than 1/10, particularly preferably less than 1/20 of the spacing between two adjacent bar elements, plates or passages of the mixing element.

8. A mixing or dispersing element in accordance with claim 1, wherein the foam structure includes a metal, a metal alloy, a ceramic material, glass, carbon and/or a plastic.

9. A mixing or dispersing element in accordance with claim 1, wherein the foam structure has a mean pore size of up to and including 100 PPI, preferably a mean pore size of 10 up to and including 100 PPI.

10. A mixing or dispersing element in accordance with claim 1, wherein the foam structure has a free volume from 40% up to 97%, preferably from 50% to 95%.

11. A mixing or dispersing element in accordance with claim 1, which contains a temperature adjusting means.

12. A mixing or dispersing element in accordance with claim 1, which is made at least partly as a catalyst surface, in particular as a hydrolysis catalyst surface.

13. A mixing or dispersing element in accordance with claim 1, wherein at least one metering element is provided for inputting a fluid into the passage (2).

14. A mixing or dispersing element in accordance with claim 13, wherein the metering element is arranged upstream of the insertion element (3, 4).

15. A method of producing a dispersion, wherein, in a first step, a first fluid and a second fluid are simultaneously introduced into a passage, wherein the first fluid is brought into contact with the second fluid in a second step in a mixing or dispersing element, wherein the mixing or dispersing element contains an insertion element for micro mixing or dispersing which contains a foam structure which is arranged in the passage as well as additionally a static mixing element for macro mixing or for predispersing or for macro dispersing is arranged in the passage, and wherein the first fluid and the second fluid are conducted in parallel flow through the mixing or dispersing element and through the insertion element, whereby the second fluid and the first fluid are mixed or dispersed.
